(19) United States
(12) Patent Application Publication
(10) Pub. No.: US 2010/0202100 A1
(43) Pub. Date: Aug. 12, 2010

(54) HIGHLY DIELECTRIC FILM

(75) Inventors: Meiten Koh, Settsu-shi (JP); Kouji Yokotani, Settsu-shi (JP); Miharu Matsumura, Settsu-shi (JP); Eri Mukai, Settsu-shi (JP); Nobuyuki Komatsu, Settsu-shi (JP)

Correspondence Address: SUGHRUE MION, PLLC, 2100 PENNSYLVANIA AVENUE, N.W., SUITE 800, WASHINGTON, DC, 20037, US

(73) Assignee: DAIKIN INDUSTRIES ,LTD., Osaka-shi ,Osaka (JP)

(21) Appl. No.: 12/670,759

(22) PCT Filed: Jul. 29, 2008
(86) PCT No.: PCT/JP2008/063566

§ 371 Date: Jan. 26, 2010

(30) Foreign Application Priority Data
Jul. 31, 2007 (JP) 2007-198873

(51) Int. Cl. H01G 4/18; B32B 5/16; B32B 5/00; B05D 3/02; C08K 3/18

(52) U.S. Cl. 361/323; 428/328; 428/220; 427/385.5; 524/413

(57) ABSTRACT

There is provided a highly dielectric film which has highly dielectric property, can be made thin, being excellent in winding property (flexibility) and assures a small dielectric loss, and the highly dielectric film comprises a vinylidene fluoride type polymer (A), and compound oxide particles (B) represented by the formula: MₐTi_{b}O_{c}, wherein M is a metallic element of the group II of from the second period to the fifth period in Periodic Table; a is from 0.9 to 1.1; b is from 0.9 to 1.1; c is from 2.8 to 3.2, and the compound oxide particles (B) are contained in an amount of 10 to 500 parts by mass based on 100 parts by mass of the vinylidene fluoride type polymer (A).

### TECHNICAL FIELD

The present invention relates to a highly dielectric film being useful, for example, as a dielectric film for a film capacitor.

### BACKGROUND ART

In recently years, plastic insulating materials are expected for film capacitors for communication, electronic devices, electric power, medium and low voltage phase advancement and inverter since they have high insulation resistance, good frequency characteristics and satisfactory flexibility. Film capacitors are used on radiocommunication devices for air planes, ships and cars, and domestic appliances such as television set, radio and audio-visual devices, and for driving of small-size motors for air conditioner, washing machine and electric fan and for improvement in electric coefficient of fluorescent lamp and mercury lamp.

A film capacitor is usually comprised of a film structure comprising a film subjected to aluminum or zinc deposition on its surface, or a film structure comprising multi-layers of aluminum foils and films, and recently there are used a lot of film capacitors comprising a film and an electrode formed thereon by metal deposition. So far, polypropylene (PP), polyethylene terephthalate (PET) and polyphenylene sulfide (PPS) films have been investigated as films for film capacitors (for example, cf. JP54-129064A). However, these films have a dielectric constant of as low as about 2.5 to about 3. A capacity of a film capacitor is proportional to a dielectric constant of a film and reversely proportional to a film thickness. Therefore, so far, making a film thinner has been studied mainly. However, if a film thickness is made too thin, film formation becomes difficult in its production and lowering of insulation voltage occurs, and thus there is a limit in decrease in a film thickness. A further smaller size and larger capacity are demanded on film capacitors, and therefore, there is a large demand for highly dielectric thin films.

So far, highly dielectric films such as polyvinylidene fluoride (PVdF) type films and films using cyano-ethylated pullulan have been studied as a highly dielectric film (for example, cf. JP59-62115A, JP62-286720A and JP60-207329A). However, dielectric constants of any of these films are low, and making a film thickness thinner is difficult.

In order to make a film having further increased dielectric constant, means for making a film by mixing inorganic ferroelectric particles having a high dielectric constant such as barium titanate or lead zirconate with a resin have been studied.

One of such means is a method of making a film by melt-kneading a resin and inorganic ferroelectric fine particles and subjecting them to melt-extrusion or inflation molding (for example, cf. JP58-69252A, JP55-62605A, JP2000-501549A and JP2000-294447A). However, in this method, there are the following two problems:

(1) making a film having a thickness of not more than 10 μm is difficult, and
(2) void is easily generated,
and therefore, the present situation is such that a thin film having a dielectric constant of not less than 17 and a thickness of not more than 9 μm has not been obtained.

There is another method of forming a thin film by mixing a resin with inorganic ferroelectric fine particles in a solution and then coating the obtained solution (for example, cf. JP4-160705A and JP2-206623A). In JP4-160705A and JP2-206623A, ferroelectric fine particles are dispersed in at least one polymer selected from the group consisting of aromatic polyamide and aromatic polyimide, followed by coating and peeling, and a film having a dielectric constant of 20 and a thickness of 10 μm can be obtained. However, in the case of a film thickness of 5 μm, only a film having a dielectric constant of 15 is obtained, and in the case of a film thickness of 3 μm, only a film having a dielectric constant of 11 is obtained. Namely, a thin film having a dielectric constant of not less than 17 and a thickness of not more than 9 μm has not been obtained. Also, since polyamide and polyimide are used as a polymer, an obtained film is one having low flexibility.

When barium titanate and lead zirconium titanate are used as inorganic ferroelectric fine particles, a dielectric loss is high within a frequency region from about several tens of Hz to about several tens of kHz, and further, a temperature coefficient of dielectric loss is high. Therefore, even if a dielectric constant is high, characteristics of them cannot be used efficiently.

### DISCLOSURE OF INVENTION

It is an object of the present invention to provide a highly dielectric film which has highly dielectric property, can be made thin, is excellent in winding property (flexibility) and assures a small dielectric loss.

The inventors of the present invention have found that the above-mentioned problems can be solved by using, as oxide particles for obtaining a high dielectric constant, compound oxide particles comprising a metallic element of the group II of from the second period to the fifth period in Periodic Table and a titanium element as a metallic element, and have completed the present invention.

Namely, the present invention relates to a highly dielectric film comprising:

(A) a vinylidene fluoride type polymer (hereinafter also referred to as “VdF type polymer (A)”), and
(B) compound oxide particles (hereinafter also referred to as “compound oxide particles (B)”) represented by the formula (B):

MₐTi_{b}O_{c}

wherein M is a metallic element of the group II of from the second period to the fifth period in Periodic Table; a is from 0.9 to 1.1; b is from 0.9 to 1.1; c is from 2.8 to 3.2, and the compound oxide particles (B) are contained in an amount of 10 to 500 parts by mass based on 100 parts by mass of the vinylidene fluoride type polymer (A).

It is preferable that a dielectric constant of the above-mentioned vinylidene fluoride type polymer (A) at 1 kHz at 25° C. is 5 to 15.

It is preferable that the above-mentioned compound oxide particles (B) are particles of magnesium titanate, calcium titanate or strontium titanate.

It is preferable that an average particle size of the compound oxide particles (B) is 0.01 to 2 μM.

It is preferable that a dielectric constant of the above-mentioned highly dielectric film at 1 kHz at 25° C. is 17 to 80, a dielectric loss of the film is 0.2 to 7% and a thickness of the film is 3 to 9 μm.

It is preferable that the above-mentioned highly dielectric film is a film for a film capacitor.

The present invention also relates to a laminated film for a film capacitor prepared by laminating an electrode layer at least on one surface of the above-mentioned highly dielectric film.

Further, the present invention relates to a film capacitor made by using the above-mentioned laminated film for a film capacitor.

Also, the present invention relates to a coating composition for forming a highly dielectric film comprising:

(A) a vinylidene fluoride type polymer,
(B) compound oxide particles represented by the formula (B):

MₐTi_{b}O_{c}

wherein M is a metallic element of the group II of from the second period to the fifth period in Periodic Table; a is from 0.9 to 1.1; b is from 0.9 to 1.1; c is from 2.8 to 3.2,
(C) at least one affinity improving agent selected from the group consisting of a coupling agent, a surfactant and an epoxy group-containing compound, and
(D) a solvent, and
the compound oxide particles (B) are contained in an amount of 10 to 500 parts by mass based on 100 parts by mass of the vinylidene fluoride type polymer (A) and the affinity improving agent (C) is contained in an amount of 0.01 to 30 parts by mass based on 100 parts by mass of the compound oxide particles (B).

It is preferable that a dielectric constant of the vinylidene fluoride type polymer (A) at 1 kHz at 25° C. is 5 to 15.

It is preferable that the above-mentioned compound oxide particles (B) are particles of magnesium titanate, calcium titanate or strontium titanate.

It is preferable that an average particle size of the above-mentioned compound oxide particles (B) is 0.01 to 2 μm.

It is preferable that the above-mentioned coating composition is used for forming a highly dielectric film for a film capacitor.

Further, the present invention relates to a method of preparing a highly dielectric film, characterized by comprising a step for coating the above-mentioned coating composition on a substrate and a step for drying.

### BEST MODE FOR CARRYING OUT THE INVENTION

The highly dielectric film of the present invention comprises the VdF type polymer (A) and the compound oxide particles (B), and the compound oxide particles (B) are contained in an amount of 10 to 500 parts by mass based on 100 parts by mass of the VdF type polymer (A).

The VdF type polymer (A) may be a vinylidene fluoride (VdF) homopolymer or may be a copolymer of VdF and other monomer copolymerizable with VdF (hereinafter also referred to as “VdF copolymer”). Also the VdF type polymer (A) may be a blend of a VdF homopolymer and a VdF copolymer or may be a blend of VdF copolymers.

Examples of other monomer copolymerizable with VdF are fluorine-containing olefins such as tetrafluoroethylene (TFE), chlorotrifluoroethylene (CTFE), trifluoroethylene (TrFE), monofluoroethylene, hexafluoropropylene (HFP) and perfluoro(alkyl vinyl ether) (PAVE); fluorine-containing acrylates and fluorine-containing monomers having functional group. Among these, from the viewpoint of good solubility in a solvent, TFE, CTFE and HFP are preferred. With respect to the copolymerization ratio, it is preferable that the amount of VdF is not less than 50% by mole, preferably not less than 60% by mole from the viewpoint of a high dielectric constant and high solubility in a solvent. In the case of a VdF/TFE copolymer, it is preferable that the copolymer comprises 60 to 95% by mole of VdF unit and 5 to 40% by mole of TFE unit, especially the copolymer comprises 70 to 90% by mole of VdF unit and 10 to 30% by mole of TFE unit, since a withstanding voltage becomes high. In order to decrease a dielectric loss of the VdF type polymer itself, it is also preferable to copolymerize with ethylene, propylene, alkyl vinyl ether, vinyl acetate, vinyl chloride, vinylidene chloride, CH₂═CHCF₃ or CH₂═CFCF₃. In this case, since such compounds hardly react directly with VdF, copolymerization can be carried out together with other copolymerizable monomers mentioned above such as TFE and CTFE. Also, it is preferable that a dielectric constant (1 kHz, 25° C.) of the VdF type polymer is not less than 5, preferably not less than 6, further preferably not less than 7.5 from the viewpoint of further increase in a dielectric constant of the film. An upper limit is not limited particularly, and is usually 15, preferably 13.

The compound oxide particles (B) are typical highly dielectric inorganic particles represented by the formula (B):

MₐTi_{b}O_{c}

wherein M is a metallic element of the group II of from the second period to the fifth period in Periodic Table; a is from 0.9 to 1.1; b is from 0.9 to 1.1; c is from 2.8 to 3.2, and dielectric constant thereof at 1 kHz at 25° C. is not less than 20.

In the formula (B), M is a metallic element of the group II of from the second period to the fifth period in Periodic Table, and examples thereof are Be, Mg, Ca and Sr. These compound oxide particles (B) are perovskite type oxides in which M in the formula (B) is a metallic element of the group II of from the second period to the fifth period in Periodic Table, and examples thereof are beryllium titanate, magnesium titanate, calcium titanate and strontium titanate. Among these, magnesium titanate, calcium titanate and strontium titanate are preferred, and further strontium titanate is preferred from the viewpoint of high dielectric constant and small dielectric loss.

It is preferable that an average particle size of the compound oxide particles (B) is 0.01 to 2 μm, preferably 0.01 to 1.0 μm, further 0.01 to 0.7 μm, from the viewpoint of surface smoothness of the film and uniform dispersibility.

The amount of compound oxide particles (B) is not less than 10 parts by mass, preferably not less than 30 parts by mass, further preferably not less than 50 parts by mass based on 100 parts by mass of the VdF type polymer (A). When the amount is too small, an effect of improving a dielectric constant of the film becomes small. An upper limit is 500 parts by mass. When the amount is too large, there occurs a problem with strength and surface roughness of the film. A preferred upper limit is 400 parts by mass, further 300 parts by mass.

To the film of the present invention may be blended, as optional components, various fillers such as a reinforcing filler, an antistatic filler and other affinity imparting agent (c) in addition to other polymer (a), other highly dielectric inorganic particles (b) and the affinity imparting agent (C).

Preferred examples of other polymer (a) are polycarbonate (PC), polyester, polyethylene terephthalate (PET), polyethylene naphthalate (PEN), silicone resin, polyether, polyvinyl acetate, polyethylene and polypropylene for improving flexibility; poly(meth)acrylate, epoxy resin, polyphenylene oxide (PPO), polyphenylene sulfide (PPS), polyamide (PA), polyimide (PI), polyamide imide (PAI), polycarbonate (PC), polystyrene and polybenzimidazole (PBI) for increasing strength; and odd number polyamide, cyano pullulan, and copper phthalocyanine polymer for supplementing high dielectric property. These other polymers (a) may be blended to an extent not to impair the object of the present invention.

In the present invention, combination use of highly dielectric inorganic particles other than the compound oxide particles (B) is not prohibited, and known highly dielectric inorganic particles may be blended.

Examples of such other highly dielectric inorganic particles (b) are compound oxides (b1) represented by the formula (b1):

M¹_{d}M²ₑo_{f}

wherein M¹ is a metallic element of the group II in Periodic Table; M² is a metallic element of the fifth period in Periodic Table; d is from 0.9 to 1.1; e is from 0.9 to 1.1; f is from 2.8 to 3.2, and compound oxides (b2) comprising at least three metallic elements selected from the group consisting of metallic elements of the group II and metallic elements of the group IV in Periodic Table.

In the formula (b1), M¹ is a metallic element of the group II in Periodic Table, and examples thereof are Mg, Ca, Sr and Ba. Also, M² is a metallic element of the fifth period in Periodic Table, and examples thereof are Zr, Nb, In, Sn and Sb.

Examples of the compound oxides (b1) are magnesium stannate, calcium stannate, strontium stannate, barium stannate, magnesium antimonate, calcium antimonate, strontium antimonate, barium antimonate, magnesium zirconate, calcium zirconate, strontium zirconate, barium zirconate, magnesium indate, calcium indate, strontium indate and barium indate.

Also, in the compound oxides (b2), examples of metallic elements of the group II in Periodic Table are Mg, Ca, Sr and Ba, and examples of metallic elements of the group IV in Periodic Table are Ti, Zr and Hf.

Examples of preferred combination of three or more elements selected from metallic elements of the group II and metallic elements of the group IV in Periodic Table are a combination of Sr, Ba and Ti, a combination of Sr, Ti and Zr, a combination of Ba, Ti and Zr, a combination of Sr, Ba, Ti and Zr, a combination of Mg, Ti and Zr, a combination of Ca, Ti and Zr, a combination of Ca, Ba and Ti, a combination of Ca, Ba and Zr, a combination of Ca, Ba, Ti and Zr, a combination of Ca, Sr and Zr, a combination of Ca, Sr, Ti and Zr, a combination of Mg, Sr and Zr, a combination of Mg, Sr, Ti and Zr, a combination of Mg, Ba, Ti and Zr, and a combination of Mg, Ba and Zr.

Examples of the compound oxides (b2) are strontium zirconium titanate, barium zirconium titanate, barium strontium zirconium titanate, magnesium zirconium titanate, calcium zirconium titanate, and barium calcium zirconium titanate.

In addition, barium titanate, lead zirconium titanate, lead antimonate, zinc titanate, lead titanate and titanium oxide can also be used as other highly dielectric inorganic particles (b).

Also, complex compounds, solid solutions and mixtures of the above-mentioned compound oxides can be exemplified. Among these, compound oxides (b1), barium titanate and lead zirconium titanate are preferred in the case of use together with the compound oxide particles (B).

It is preferable that an average particle size of other highly dielectric inorganic particles (b) is 0.01 to 2 μam, preferably 0.01 to 1 μm, further 0.01 to 0.7 μm, especially 0.01 to 0.5 μm, further 0.01 to about 0.2 μm, from the viewpoint of surface smoothness of the film and uniform dispersibility.

These other highly dielectric inorganic particles (b) can be blended to an extent not to impair the object of the present invention, and it is preferable that the amount thereof is 10 to 500 parts by mass, preferably 30 to 400 parts by mass, further 50 to 300 parts by mass based on 100 parts by mass of the VdF type polymer (A), from the viewpoint of dielectric constant of the film, strength of the film and less surface roughness of the film. In addition, highly dielectric organic compounds, for example, copper phthalocyanine tetramer may be blended to an extent not to impair the object of the present invention.

The affinity improving agent (C), when blended, plays a role of not only improving affinity of the VdF type polymer (A) for the compound oxide particles (B) and dispersing the compound oxide particles (B) uniformly in the VdF type polymer but also strongly bonding the compound oxide particles (B) and the VdF type polymer (A) in the film, thereby inhibiting generation of voids and enabling a dielectric constant to be increased. Further, in the case of blending the other highly dielectric inorganic particles (b), the affinity improving agent (C) functions to improve affinity of the VdF type polymer (A) for the other highly dielectric inorganic particles (b).

Examples of the effective affinity improving agent (C) are a coupling agent (C1), a surfactant (C2) and an epoxy group-containing compound (C3).

Examples of the coupling agent (C1) are titanate coupling agents, silane coupling agents, zirconium coupling agents and zircoaluminate coupling agents.

Examples of the titanate coupling agents are those of monoalkoxy type, chelate type and coordinate type, and especially from the viewpoint of satisfactory affinity for the compound oxide particles (B), monoalkoxy type and chelate type are preferred. In the case of blending the other highly dielectric inorganic particles (b), monoalkoxy type and chelate type have good affinity for the other highly dielectric inorganic particles (b).

Examples of the silane coupling agents are those of high molecular weight type and low molecular weight type, and from the viewpoint of the number of functional groups, there are monoalkoxysilane, dialkoxysilane, trialkoxysilane and Dipodal alkoxysilane. Especially from the viewpoint of good affinity for the compound oxide particles (B), alkoxysilanes of low molecular weight type are preferred. In the case of blending the other highly dielectric inorganic particles (b), alkoxysilanes of low molecular weight type also have good affinity for the other highly dielectric inorganic particles (b).

Examples of the zirconium coupling agents are mono alkoxyzirconium and trialkoxyzirconium.

Examples of the zircoaluminate coupling agents are monoalkoxyzircoaluminate and trialkoxyzircoaluminate.

Examples of the surfactant (C2) are those of high molecular weight type and low molecular weight type, and from the viewpoint of kind of functional groups, there are nonionic surfactants, anionic surfactants and cationic surfactants. Those can be used, and surfactants of high molecular weight type are preferred from the viewpoint of satisfactory thermal stability.

Examples of the nonionic surfactants are polyether derivatives, polyvinyl pyrrolidone derivatives and alcohol derivatives, and polyether derivatives are preferred especially from the viewpoint of good affinity for the compound oxide particles (B). In the case of blending the other highly dielectric inorganic particles (b), polyether derivatives also have good affinity for the other highly dielectric inorganic particles (b).

Examples of the anionic surfactants are polymers having moiety of sulfonic acid, carboxylic acid or salt thereof, and especially from the viewpoint of good affinity for the VdF type polymer (A), preferable are acrylic acid derivative polymers, methacrylic acid derivative polymers, and maleic anhydride copolymers.

Examples of the cationic surfactants are amine compounds, compounds having a nitrogen-containing complex ring such as imidazoline, and halogenated salts thereof, and compounds having a nitrogen-containing complex ring are preferred since they have less property of attacking the VdF type polymer (A). Examples of the salts are ammonium salts having halogen anion such as alkyl trimethylammonium chloride. From the viewpoint of a high dielectric constant, ammonium salts having halogen anion are preferred.

Examples of the epoxy group-containing compounds (C3) are epoxy compounds and glycidyl compounds, which may be low molecular weight compounds or high molecular weight compounds. Among these, low molecular weight compounds having one epoxy group are preferred from the viewpoint of especially satisfactory affinity for the VdF type polymer (A). In the present invention, epoxy group-containing coupling agents (for example, epoxysilane) which are classified into a coupling agent are included in the coupling agent (C1) but not in the epoxy group-containing compound (C3).

From the viewpoint of especially satisfactory affinity for the VdF type polymer (A), preferable examples of the epoxy group-containing compound (C3) are compounds represented by the formula (C3):

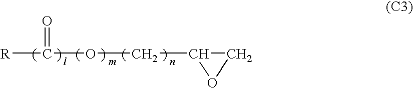

wherein R is hydrogen atom, a monovalent hydrocarbon group having 1 to 10 carbon atoms which may have oxygen atom, nitrogen atom or carbon-carbon double bond, or an aromatic ring which may have a substituent; 1 is 0 or 1; m is 0 or 1; n is 0 or an integer of 1 to 10.

Examples thereof are:

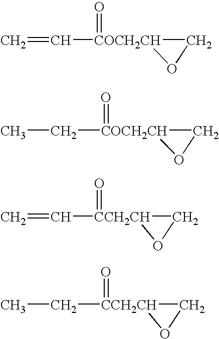

and the like, which have a ketone group or an ester group.

The affinity improving agent (C) can be blended to an extent not to impair the object of the present invention, and an amount of the affinity improving agent (C) is preferably 0.01 to 30 parts by mass, further preferably 0.1 to 25 parts by mass, especially preferably 1 to 20 parts by mass based on 100 parts by mass of the compound oxide particles (B) since the affinity improving agent (C) can be dispersed uniformly and a dielectric constant of the obtained film is high. From the viewpoint of satisfactory affinity for the compound oxide particles (B), the coupling agent (C1) and the epoxy group-containing compound (C3) are preferred as the affinity improving agent (C), and especially titanate coupling agents and silane coupling agents are preferred from the viewpoint of satisfactory affinity for both of the VdF type polymer (A) and the compound oxide particles (B). In the case of blending the other highly dielectric inorganic particles (b), the coupling agent (C1) and the epoxy group-containing compound (C3), especially titanate coupling agents and silane coupling agents also have good affinity for the other highly dielectric inorganic particles (b).

In addition, the coupling agent (C1) and the epoxy group-containing compound (C3) exhibit more satisfactory affinity improving action since they form a chemical bond with the compound oxide particles (B) (having a reaction group). In the case of blending the other highly dielectric inorganic particles (b), the coupling agent (C1) and the epoxy group-containing compound (C3) also form a bond with the other highly dielectric inorganic particles (b).

Examples of reinforcing fillers are particles and fibers of silicon carbide, silicon nitride, magnesium oxide, potassium titanate, glass, alumina, and boron compounds, and examples of fillers for decreasing a dielectric loss are calcium oxide, magnesium oxide, alumina, silica, calcium carbonate, magnesium carbonate and bismuth oxide. Examples of other affinity improving agent (c) are polyolefin modified with functional group, styrene-modified polyolefin, polystyrene modified with functional group, polyacrylate imide and cumylphenol. These may be blended to an extent not to impair the object of the present invention.

For formation of the highly dielectric film of the present invention, (1) a melt-kneading method and (2) a coating method are used.

The melt-kneading method (1) is a method of melt-kneading the polymer and the compound oxide particles, making a film by a melt-extrusion method or an inflation method and if necessary, carrying out stretching treatment. The coating method (2) is a method of dissolving the polymer in a solvent, adding and mixing the compound oxide particles thereto to make a coating composition and preparing a film by coating.

The highly dielectric film of the present invention can be produced by either of the above-mentioned melt-kneading method (1) and the coating method (2). From the viewpoint of easy production and excellent homogeneity of an obtained film, it is advantageous to produce by the coating method (2).

In the case of producing a highly dielectric film by the coating method, first a coating composition is prepared. The coating composition of the present invention is a coating composition comprising:

(A) a VdF type polymer,
(B) compound oxide particles represented by the formula (B):

MₐTi_{b}O_{c}

wherein M is a metallic element of the group II of from the second period to the fifth period in Periodic Table; a is from 0.9 to 1.1; b is from 0.9 to 1.1; c is from 2.8 to 3.2,
(C) at least one affinity improving agent selected from the group consisting of a coupling agent, a surfactant and an epoxy group-containing compound, and
(D) a solvent,
and the compound oxide particles (B) are contained in an amount of 10 to 500 parts by mass based on 100 parts by mass of the vinylidene fluoride type polymer (A) and the affinity improving agent (C) is contained in an amount of 0.01 to 30 parts by mass based on 100 parts by mass of the compound oxide particles (B).

With respect to examples and amounts of the VdF type polymer (A), the compound oxide particles (B), the affinity improving agent (C) and other optional components, the above-mentioned explanations can be applied.

It is preferable to adjust a viscosity of this coating composition to 0.01 to 3 Pa·s with the solvent (D) since coatability is satisfactory and a uniform and smooth film can be obtained. It is especially preferable that the viscosity is not more than 1.5 Pa·s, from the viewpoint of inhibiting roughening of a film surface.

A form of the coating composition may be an emulsion (a solvent is water, etc.). In this case, since both of the VdF type polymer (A) and the compound oxide particles (B) are in the form of particles, a particle-particle mixture system is formed and uniformly dispersing is difficult. Therefore, it is preferable to prepare a solution of the VdF type polymer (A) dissolved in an organic solvent and disperse the compound oxide particles (B) in this solution because uniform dispersing is easy and a uniform film can be easily obtained.

Preferable examples of the solvent (D) dissolving the VdF type polymer (A) are amide solvents such as N,N-dimethylformamide (DMF), N-methylpyrrolidone (NMP) and N,N-dimethylacetamide (DMAc); ketone solvents such as cyclohexane, methyl isobutyl ketone (MIBK) and 2-heptanone (MAK); ester solvents such as butyl acetate and ethyl lactate; ether solvents such as ethyl cellosolve and methyl cellosolve; and carbonate solvents such as propylene carbonate and diethylene carbonate (DEC), and from the viewpoint of especially good solubility of the VdF type polymer (A), amide solvents are preferred. These solvents may be used alone or may be mixed optionally. Especially a solvent mixture comprising an amide solvent as a main solvent and an ester, ketone, ether or carbonate solvent as an auxiliary solvent has good wettability to a substrate and therefore is suitable for forming a uniform thin film having less pin holes. Particularly for enhancing solubility of the VdF type polymer (A), it is preferable to adjust a dielectric constant of a solvent at 1 kHz at 25° C. to be not less than 22, and for improving coatability, it is preferable to adjust a surface tension of a solvent to be not more than 35 dyn/cm.

In addition to the solvent (D), to the coating composition may be added a defoaming agent, a dispersant, a wetting agent, a leveling agent and a flowing agent as components not remaining in the film (disappearing at the time of forming the film) or as components which do not give substantial influence on the effects (high dielectric constant, flexibility, formation of thin film, small dielectric loss) aimed at by the film of the present invention even if they are present in the film.

The coating composition is prepared by preparing the solvent (D) solution of the VdF type polymer (A), optionally adding other components thereto, and then forcedly stirring and dispersing the mixture. Specifically there are the following methods.

(1) A method of previously mixing, stirring and dispersing the compound oxide particles (B) and the affinity improving agent (C) in the solvent (D), and then sufficiently stirring and dispersing the obtained dispersed mixture and the solution of the VdF type polymer (A):

In this method, in the case where the affinity improving agent (C) is the coupling agent (C1) or the epoxy group-containing compound (C3) which is a chemically reactive affinity improving agent, the affinity improving agent (C) and the compound oxide particles (B) may be subjected to forced stirring and dispersing after the reaction thereof, or may be added to the solvent (D) and then subjected to the reaction and forced stirring and dispersing simultaneously, or the both may be carried out. When the affinity improving agent (C) is the surfactant (C2), since a reaction does not occur, it is easy to add the compound oxide particles (B) and the affinity improving agent (C) in the solvent (D) and then carry out the reaction and forced stirring and dispersing simultaneously.

For enhancing stability of a dispersed mixture of the compound oxide particles (B) and the affinity improving agent (C), it is desirable that a small amount of a solution of the VdF type polymer (A) is present when forcedly stirring and dispersing the compound oxide particles (B) and the affinity improving agent (C).

(2) A method of adding the compound oxide particles (B) and the affinity improving agent (C) in the solvent (D) solution of the VdF type polymer (A) batchwise or in order and carrying out forced stirring and dispersing:

When adding in order, the order of adding is not limited particularly, and forced stirring and dispersing treatment may be carried out every time when one component is added.

In any of the above-mentioned methods (1) and (2), it is desirable to previously remove adsorbed water on a surface of the compound oxide particles (B) by heat treatment or the like since uniform dispersibility is further improved. By subjecting the compound oxide particles (B) to pre-heat treatment or surface treatment, uniform dispersing becomes easy even in the case of the compound oxide particles (B) having a large average particle size. It is desirable to carry out the both of pre-heat treatment and surface treatment.

A specified amount of each component may be added batchwise or dividedly. When adding dividedly, the adding order and the divided addition may be combined freely, for example, in such a manner that a part of the VdF type polymer (A) is previously added when mixing the compound oxide particles (B) and the affinity improving agent (C), and the remaining VdF type polymer (A) is added after the mixing, and further the affinity improving agent (C) is added and mixed additionally.

Here, an important point is to sufficiently carry out forced stirring and dispersing. If this dispersing treatment is insufficient, there is a case where solid contents such as the compound oxide particles (B) are easily sedimented, thereby making coating difficult, and in some cases, at forming a coating film by drying, phase separation occurs inside the film, and a uniform film being excellent in mechanical characteristics and having stable dielectric characteristics cannot be formed. This forced stirring and dispersing treatment may be carried out for the prepared composition just before the coating.

The forced stirring and dispersing is to be carried out to such an extent that the composition after the stirring and dispersing does not cause phase separation (a change of turbidity of the solution is small (10% or less)) even in the case of allowing the composition to stand at room temperature (25° C.) for seven days. A degree of the stirring and dispersing can be set by preliminary experiments.

Preferable examples of forced stirring and dispersing equipment are ball mill, sand mill, attrition mill, Visco Mill, roll mill, banbury mixer, stone mill, vibrator mill, dispersing mill, disc impeller, jet mill and DYNO-MILL. Among these, jet mill, roll mill and DYNO-MILL are preferred from the viewpoint that mixing of impurities hardly occurs and continuous production can be carried out.

Nonlimiting examples of the forced stirring and dispersing conditions are as follows.

Equipment: Sand mill
Stirring conditions:

Stirring speed: 100 to 10,000 rpm

Stirring time: 5 to 120 minutes

Others: Zirconia beads are used.

A film is formed using the obtained uniform coating composition. It is preferable to carry out film formation by coating the composition on a substrate and then drying and if necessary, peeling the film from the substrate, from the viewpoint of easy operation, a simple structure of equipment and easy control of a film thickness. Also film formation may be conducted by other film forming methods such as a method of Langmuir-Blodgett's technique and an impregnation method.

For the coating, a knife coating method, a cast coating method, a roll coating method, a gravure coating method, a blade coating method, a rod coating method, an air doctor coating method, a curtain coating method, a Faknelane coating method, a kiss coating method, a screen coating method, a spin coating method, a spray coating method, an extrusion coating method, and an electrodeposition coating method can be employed. Among these, a roll coating method, a gravure coating method and a cast coating method are preferred from the viewpoint that operation is easy, non-uniformity of a film thickness is small and productivity is satisfactory.

Drying can be conducted using Yankee cylinder, counter flow, hot air blasting, air flow cylinder, air through, infrared ray, microwave, and induction heating. For example, in the case of a hot air blasting method, the drying conditions of 130° to 200° C. for a period of time of one minute or less are suitably adopted.

The highly dielectric film of the present invention may be left on a substrate as a so-called coating film. When the film is used as a film for a film capacitor, it is separated from a substrate and used in the form of a single film. Therefore, preferable materials for a substrate are those from which the VdF type polymer (A) is easily peeled, for example, metallic sheets of stainless steel and copper; glass sheet; polymer films subjected to ITO and ZnO deposition; and polymer films having good releasing property. Examples of suitable polymer films are engineering plastics such as polyethylene terephthalate (PET), polyethylene naphthalate (PEN), polycarbonate (PC), polyamide (PA), polyimide (PI), polyamide imide (PAI), polybenzimidazole (PBI), polyphenylene sulfide (PPS), polyphenylene oxide (PPO) and polysulfone (PSF).

When the film is left on a substrate as a coating film, the coating composition of the present invention can be coated on a polymer film and dried to make a laminated film. Preferable as a substrate for the laminated film are polymer films which have good adhesion to the VdF type polymer (A) and have a thickness of about 1.5 to 3 μm. Examples of suitable polymers are engineering plastics such as PET, PEN, PC, PA, PI, PAI, FBI, PPS, PPO and PSF.

A single film is used as it is, and may be stretched by usual method. In that case, a stretching ratio is desirably about 2 to 6 times.

In any of single films and laminated films, they may be subjected to surface treatment with other kind of polymer or plasma treatment or corona discharge treatment in order to make deposition of aluminum for an electrode easy. In addition, in order to inhibit roughening of a film surface, other kind of polymer may be coated on a film surface, and in order to improve film strength, a film may be subjected to crosslinking treatment with ultraviolet ray, electron beam or radiation. Further, a film may be subjected to pressing, for example, pressing with rolls. In that case, surface smoothness of a film is improved.

A thickness of the so-obtained highly dielectric film of the present invention can be not more than 9 μm, preferably not more than 6 μm, further preferably not more than 5 μm. A lower limit of the film thickness varies depending on kind of a polymer and a particle size and an amount of the compound oxide particles (B), and is 3 μm from the viewpoint of maintaining mechanical strength of a film. In addition, the dielectric constant of the highly dielectric film of the present invention at 1 kHz at 25° C. can be not less than 17, further not less than 20, and the dielectric loss of the film can be not more than 7%, further not more than 5%. An upper limit of the dielectric constant varies depending on kind of the polymer and a particle size and an amount of the compound oxide particles (B), and is usually about 80. A lower limit of the dielectric loss varies depending on kind of the polymer and a particle size and an amount of the compound oxide particles (B), and is usually about 0.2%.

In the highly dielectric film of the present invention, in spite of relatively high content of compound oxide particles (B) (10% by mass or more), a film thickness can be made thin, and therefore, electrostatic capacity can be made high. For example, when strontium titanate particles having a dielectric constant of 2,000 are used as the compound oxide particles (B) and the content thereof is 100% by mass, a dielectric constant of the film at 1 kHz at 25° C. can be 30 or more. In this case, assuming an area of a circular electrode is 9.5 mm², an electrostatic capacity of a film having a thickness of 9 μm is 2.8 nF or more, and an electrostatic capacity of a film having a thickness of 6 μm is 4.2 nF or more.

Also, according to the film of the present invention, when the coupling agent (C1) or the epoxy group-containing compound (C3) is blended, by an action of it, the compound oxide particles (B) are bonded firmly to the VdF type polymer (A), and a dense structure having a small void content (for example, not more than 5% by volume, preferably not more than 1% by volume) is achieved and a withstanding voltage can be made high.

In spite of a dense structure, the film of the present invention is excellent in flexibility (winding property). For example, in the case of a 5 μm thick film, neither cracking nor breaking occurs at 180 degree bending test. Therefore, when the film is used for a film capacitor, processability (winding property and followability) is significantly improved.

The film of the present invention is excellent in surface smoothness, and for example, surface roughness of its center can be not more than ±1 μm, further not more than ±0.6 μm. Uniformity of electrical characteristics is improved due to excellent surface smoothness.

When the highly dielectric film of the present invention is used, for example, as a film for a film capacitor, an electrode is formed on a highly dielectric film surface by a deposition method or the like to make a laminated film which can be used as a film capacitor. With respect to a material of an electrode, and a method and conditions for forming an electrode, those generally known can be employed.

The highly dielectric film of the present invention is useful especially as a film for a film capacitor, and also useful as a film for piezoelectric element, a film for a pyroelectric device, a dielectric film for transfer printing carrier and a film for ferroelectric element.

### EXAMPLES

The present invention is then explained by means of Examples, but is not limited to them.

Characteristic values used herein are those measured by the following methods.

### (Dielectric Constant, Dielectric Loss)

By using a film of a mixture of a polymer and inorganic fine particles formed on a metallic substrate or a film of a mixture of a polymer and inorganic fine particles subjected to aluminum deposition on one surface thereof, a sample is produced by aluminum deposition in vacuo on a 95 mm² area of a film surface opposite to the substrate (or the aluminum-deposited surface). An electrostatic capacity and a dielectric loss of this sample are measured at room temperature (25° C.) and at 100° C. at a frequency of 100 Hz, 1 kHz and 10 kHz using an impedance analyzer (HP4194A available from Hewlett Packard).

### (Film Thickness)

A thickness of a film on a substrate is measured at room temperature using a digital length meter DIGIMICRO (MF-1001 available from Nikon Corporation).

### (Flexibility)

After bending a film having a length of 20 mm, a width of 5 mm and a thickness of 5 μM by 180 degrees, cracking and deformation at a bent portion are observed with naked eyes. When there is neither cracking nor deformation at the bent portion, it is evaluated as 0.

### Example 1

Into a 3-liter separable flask were poured 800 parts by mass of N,N-dimethylacetamide (DMAc) (available from Kishida Chemical Co., Ltd.) and 200 parts by mass of vinylidene fluoride (VdF) homopolymer (KAYNAR761 available from ARKEMA, dielectric constant: 9.6 (1 kHz, 25° C.)), and 3-hour stirring was carried out at 80° C. with a mechanical stirrer to obtain a polymer solution having a concentration of 20% by mass. This polymer solution was a transparent uniform solution.

To this solution were added 100 parts by mass of strontium titanate (ST) (ST-03 available from Sakai Chemical Industry Co., Ltd.) having an average particle size of 0.3 μm, 60 parts by mass of DMAc, 40 parts by mass of methyl isobutyl ketone (MIBK) and further 5 parts by mass of PLANEACT KR-55 available from Ajinomoto Fine-Techno Co. Inc. as a titanate coupling agent.

To this mixture were added 1 mm diameter zirconia beads in the same mass amount, and the mixture was then poured into a portable epicyclic ball mill (Planet M available from Yugen Kaisha Gokin Planetaring), followed by 15-minute dispersion treatment at room temperature at 800 rpm. The mixture after the dispersion treatment was passed through a stainless steel mesh (80 mesh available from MANABE KOGYO CO., LTD.) to remove zirconia beads and obtain a dispersion of compound oxides.

34 parts by mass of this dispersion (containing 16.6 parts by mass of strontium titanate, 0.83 part by mass of titanate coupling agent, 10.0 parts by mass of DMAc and 6.63 parts by mass of MIBK), 50 parts by mass of DMAc solution of VdF homopolymer (containing 10.0 parts by mass of VdF homopolymer and 40.0 parts by mass of DMAc) and 26.7 parts by mass of MIBK were mixed to prepare a coating composition of the present invention.

Then, the obtained composition was coated on an aluminum substrate with a bar coater, and dried with hot air at 180° C. for one minute to form an about 5.0 μm thick dielectric film.

A dielectric constant and dielectric loss at each frequency and flexibility of the obtained film were evaluated. The results are shown in Table 1.

### Example 2

A coating composition of the present invention was prepared in the same manner as in Example 1 except that kind of the compound oxide particles (B) was changed to calcium titanate (CT) (CTG available from Nippon Chemical Industrial Co, Ltd.) having an average particle size of 1.0 μm, and then an about 5.0 μm thick dielectric film was formed in the same manner as in Example 1. A dielectric constant and dielectric loss at each frequency and flexibility of the obtained film were evaluated. The results are shown in Table 1.

### COMPARATIVE EXAMPLE 1

A coating composition of the present invention was prepared in the same manner as in Example 1 except that kind of the compound oxide particles (B) was changed to barium titanate (BT) (BT-01 available from Sakai Chemical Industry Co., Ltd.) having an average particle size of 0.1 μm, and then a 5.0 μm thick dielectric film was formed in the same manner as in Example 1. A dielectric constant and dielectric loss at each frequency and flexibility of the obtained film were evaluated. The results are shown in Table 1.

### Example 3

A coating composition of the present invention was prepared in the same manner as in Example 1 except that the compound oxide particles (B) were changed to ST (HPST-1S available from FUJI TITANIUM INDUSTRY CO., LTD.) having an average particle size of 0.4 μm, and then a 5.0 μm thick dielectric film was formed in the same manner as in Example 1. A dielectric constant and dielectric loss at each frequency and flexibility of the obtained film were evaluated. The results are shown in Table 1.

TABLE 1

| | | | | Com. |
|---|---|---|---|---|
| | Ex. | | | Ex. |
| | 1 | 2 | 3 | 1 |
| Composition (part by mass) | | | | |
| VdF homopolymer (solid content) | 10 | 10 | 10 | 10 |
| Compound oxide | | | | |
| Kind | ST | CT | ST | BT |
| Average particle size (μm) | 0.3 | 1.0 | 0.4 | 0.1 |
| Amount | 16.6 | 16.6 | 16.6 | 16.6 |
| Amount based on 100 parts by | 166 | 166 | 166 | 166 |
| mass of polymer | | | | |
| (part by mass) | | | | |
| Titanate coupling agent | | | | |
| Amount | 0.83 | 0.83 | 0.83 | 0.83 |
| Amount based on 100 parts by | 5.0 | 5.0 | 5.0 | 5.0 |
| mass of compound oxide | | | | |
| (part by mass) | | | | |
| Solvent | | | | |
| DMAc | 50.0 | 50.0 | 50.0 | 50.0 |
| MIBK | 33.3 | 33.3 | 33.3 | 33.3 |
| Characteristics of film | | | | |
| Film thickness (μm) | 5.0 | 5.0 | 5.0 | 5.0 |
| Dielectric constant (25° C.) | | | | |
| 100 Hz | 40 | 19 | 37 | 48 |
| 1 kHz | 39 | 18 | 33 | 43 |
| 10 kHz | 38 | 18 | 32 | 41 |
| Dielectric constant (100° C.) | | | | |
| 100 Hz | 46 | 21 | 40 | 64 |
| 1 kHz | 40 | 20 | 35 | 51 |
| 10 kHz | 36 | 18 | 31 | 45 |
| Dielectric loss (25° C.) (%) | | | | |
| 100 Hz | 4.0 | 3.4 | 7.8 | 9.4 |
| 1 kHz | 1.7 | 2.4 | 5.6 | 5.3 |
| 10 kHz | 1.9 | 1.4 | 2.7 | 3.5 |
| Dielectric loss (100° C.) (%) | | | | |
| 100 Hz | 9.4 | 8.4 | 7.8 | 27.4 |
| 1 kHz | 7.7 | 5.1 | 8.6 | 15.2 |
| 10 kHz | 5.8 | 4.8 | 8.6 | 10.8 |
| Flexibility | ◯ | ◯ | ◯ | ◯ |

### Example 4

A coating composition of the present invention was prepared in the same manner as in Example 1 except that 50 parts by mass of ST (ST-03 available from Sakai Chemical Industry Co., Ltd.) having an average particle size of 0.3 μm and 50 parts by mass of calcium stannate (CS) (CS available from Kyoritsu Material Co., Ltd.) having an average particle size of 6 μm were used as the compound oxide particles (B) instead of 100 parts by mass of ST (ST-03 available from Sakai Chemical Industry Co., Ltd.) having an average particle size of 0.3 μm, and then a 7.5 μm thick dielectric film was formed in the same manner as in Example 1. A dielectric constant and dielectric loss at each frequency and flexibility of the obtained film were evaluated. The results are shown in Table 2.

### Example 5

A coating composition of the present invention was prepared in the same manner as in Example 1 except that 50 parts by mass of CT (CTG available from Nippon Chemical Industrial Co., Ltd.) having an average particle size of 1.0 μm and 50 parts by mass of BT (BT-01 available from Sakai Chemical Industry Co., Ltd.) having an average particle size of 0.1 μm were used as the compound oxide particles (B) instead of 100 parts by mass of ST (ST-03 available from Sakai Chemical Industry Co., Ltd.) having an average particle size of 0.3 μm, and then a 5.0 μm thick dielectric film was formed in the same manner as in Example 1. A dielectric constant and dielectric loss at each frequency and flexibility of the obtained film were evaluated. The results are shown in Table 2.

### Example 6

A coating composition of the present invention was prepared in the same manner as in Example 1 except that 50 parts by mass of CT (CTG available from Nippon Chemical Industrial Co., Ltd.) having an average particle size of 1.0 μm and 50 parts by mass of CS (CS available from Kyoritsu Material Co., Ltd.) having an average particle size of 6 μm were used as the compound oxide particles (B) instead of 100 parts by mass of ST (ST-03 available from Sakai Chemical Industry Co., Ltd.) having an average particle size of 0.3 μm, and then a 7.5 μm thick dielectric film was formed in the same manner as in Example 1. A dielectric constant and dielectric loss at each frequency and flexibility of the obtained film were evaluated. The results are shown in Table 2.

### Example 7

A coating composition of the present invention was prepared in the same manner as in Example 1 except that 50 parts by mass of ST (ST-03 available from Sakai Chemical Industry Co., Ltd.) having an average particle size of 0.3 μm and 50 parts by mass of BT (BT-01 available from Sakai Chemical Industry Co., Ltd.) having an average particle size of 0.1 μm were used as the compound oxide particles (B) instead of 100 parts by mass of ST (ST-03 available from Sakai Chemical Industry Co., Ltd.) having an average particle size of 0.3 μm, and then a 5.0 μm thick dielectric film was formed in the same manner as in Example 1. A dielectric constant and dielectric loss at each frequency and flexibility of the obtained film were evaluated. The results are shown in Table 2.

TABLE 2

| | Ex. | | | |
|---|---|---|---|---|
| | 4 | 5 | 6 | 7 |
| Composition (part by mass) | | | | |
| VdF homopolymer (solid content) | 10 | 10 | 10 | 10 |
| Compound oxide (1) | | | | |
| Kind | ST | CT | CT | ST |
| Average particle size (μm) | 0.3 | 1.0 | 1.0 | 0.3 |
| Amount | 8.3 | 8.3 | 8.3 | 8.3 |
| Amount based on 100 parts by mass | 83 | 83 | 83 | 83 |
| of polymer (part by mass) | | | | |
| Compound oxide (2) | | | | |
| Kind | CS | BT | CS | BT |
| Average particle size (μm) | 6 | 0.1 | 6 | 0.1 |
| Amount | 8.3 | 8.3 | 8.3 | 8.3 |
| Amount based on 100 parts by mass | 83 | 83 | 83 | 83 |
| of polymer (part by mass) | | | | |
| Titanate coupling agent | | | | |
| Amount | 0.83 | 0.83 | 0.83 | 0.83 |
| Amount based on 100 parts by mass | 5.0 | 5.0 | 5.0 | 5.0 |
| of compound oxide (part by mass) | | | | |
| Solvent | | | | |
| DMAc | 50.0 | 50.0 | 50.0 | 50.0 |
| MIBK | 33.3 | 33.3 | 33.3 | 33.3 |
| Characteristics of film | | | | |
| Film thickness (μm) | 7.5 | 5.0 | 7.5 | 5.0 |
| Dielectric constant (25° C.) | | | | |
| 100 Hz | 33 | 35 | 22 | 44 |
| 1 kHz | 28 | 32 | 20 | 41 |
| 10 kHz | 27 | 31 | 18 | 40 |
| Dielectric loss (25° C.) (%) | | | | |
| 100 Hz | 5.2 | 6.1 | 5.1 | 6.7 |
| 1 kHz | 2.3 | 3.6 | 2.7 | 3.3 |
| 10 kHz | 1.9 | 2.3 | 1.7 | 2.6 |

### Example 8

A coating composition of the present invention was prepared in the same manner as in Example 1 except that the amount of ST (ST-03 available from Sakai Chemical Industry Co., Ltd.) having an average particle size of 0.3 μm as the compound oxide particles (B) was changed to 20 parts by mass and the amount of titanate coupling agent was changed to 1.0 part by mass, and then a 5.0 μm thick dielectric film was formed in the same manner as in Example 1. A dielectric constant and dielectric loss at each frequency and flexibility of the obtained film were evaluated. The results are shown in Table 3.

### Example 9

A coating composition of the present invention was prepared in the same manner as in Example 1 except that the amount of ST (ST-03 available from Sakai Chemical Industry Co., Ltd.) having an average particle, size of 0.3 μm as the compound oxide particles (B) was changed to 25 parts by mass and the amount of titanate coupling agent was changed to 1.25 parts by mass, and then a 5.0 μm thick dielectric film was formed in the same manner as in Example 1. A dielectric constant and dielectric loss at each frequency and flexibility of the obtained film were evaluated. The results are shown in Table 3.

### Example 10

A coating composition of the present invention was prepared in the same manner as in Example 1 except that the amount of ST (ST-03 available from Sakai Chemical Industry Co., Ltd.) having an average particle size of 0.3 μm as the compound oxide particles (B) was changed to 5 parts by mass and the amount of titanate coupling agent was changed to 0.25 part by mass, and then a 5.0 μm thick dielectric film was formed in the same manner as in Example 1. A dielectric constant and dielectric loss at each frequency and flexibility of the obtained film were evaluated. The results are shown in Table 3.

TABLE 3

Ex.

| | 8 | 9 | 10 |
|---|---|---|---|
| Composition (part by mass) | | | |
| VdF homopolymer (solid content) | 10 | 10 | 10 |
| Compound oxide | | | |
| Kind | ST | ST | ST |
| Average particle size (μm) | 0.3 | 0.3 | 0.3 |
| Amount | 20 | 25 | 5 |
| Amount based on 100 parts by mass | 200 | 250 | 50 |
| of polymer (part by mass) | | | |
| Titanate coupling agent | | | |
| Amount | 1.0 | 1.25 | 0.25 |
| Amount based on 100 parts by mass | 5.0 | 5.0 | 5.0 |
| of compound oxide (part by mass) | | | |
| Solvent | | | |
| DMAc | 50.0 | 50.0 | 50.0 |
| MIBK | 33.3 | 33.3 | 33.3 |
| Characteristics of film | | | |
| Film thickness (μm) | 5.0 | 5.0 | 5.0 |
| Dielectric constant (25° C.) | | | |
| 100 Hz | 43 | 45 | 17 |
| 1 kHz | 42 | 44 | 16 |
| 10 kHz | 40 | 42 | 14 |
| Dielectric constant (100° C.) | | | |
| 100 Hz | 49 | 52 | 20 |
| 1 kHz | 43 | 46 | 19 |
| 10 kHz | 38 | 41 | 16 |
| Dielectric loss (25° C.) (%) | | | |
| 100 Hz | 3.8 | 3.7 | 5.0 |
| 1 kHz | 1.5 | 1.5 | 2.3 |
| 10 kHz | 1.8 | 1.7 | 2.7 |
| Dielectric loss (100° C.) (%) | | | |
| 100 Hz | 8.5 | 8.2 | 9.9 |
| 1 kHz | 7.2 | 6.9 | 8.5 |
| 10 kHz | 5.1 | 5.0 | 6.6 |
| Flexibility | ◯ | ◯ | ◯ |

### Example 11

A coating composition of the present invention was prepared in the same manner as in Example 1 except that 16.6 parts by mass of magnesium titanate (MT) (MT available from Kyoritsu Material Co., Ltd.) having an average particle size of 1.0 μm was used as the compound oxide particles (B) instead of ST (ST-03 available from Sakai Chemical Industry Co., Ltd.) having an average particle size of 0.3 μm, and then a 5.0 μm thick dielectric film was formed in the same manner as in Example 1. A dielectric constant and dielectric loss at each frequency and flexibility of the obtained film were evaluated. The results are shown in Table 4.

### Example 12

A coating composition of the present invention was prepared in the same manner as in Example 1 except that a vinylidene fluoride (VdF)/hexafluoropropylene (HFP) copolymer (KAYNAR2801 available from ARKEMA, dielectric constant: 11 (1 kHz, 25° C.)) was used as the vinylidene fluoride type polymer, and then a 5.0 μm thick dielectric film was formed in the same manner as in Example 1. A dielectric constant and dielectric loss at each frequency and flexibility of the obtained film were evaluated. The results are shown in Table 4.

TABLE 4

Ex.

| | 11 | 12 |
|---|---|---|
| Composition (part by mass) | | |
| VdF homopolymer (solid content) | 10 | — |
| VdF/HFP copolymer (solid content) | — | 10 |
| Compound oxide | | |
| Kind | MT | ST |
| Average particle size (μm) | 1.0 | 0.3 |
| Amount | 16.6 | 16.6 |
| Amount based on 100 parts by mass | 166 | 166 |
| of polymer (part by mass) | | |
| Titanate coupling agent | | |
| Amount | 0.83 | 0.83 |
| Amount based on 100 parts by mass | 5.0 | 5.0 |
| of compound oxide (part by mass) | | |
| Solvent | | |
| DMAc | 50.0 | 50.0 |
| MIBK | 33.3 | 33.3 |
| Characteristics of film | | |
| Film thickness (μm) | 5.0 | 5.0 |
| Dielectric constant (25° C.) | | |
| 100 Hz | 10 | 42 |
| 1 kHz | 9 | 40 |
| 10 kHz | 9 | 39 |
| Dielectric constant (100° C.) | | |
| 100 Hz | 15 | 48 |
| 1 kHz | 12 | 42 |
| 10 kHz | 12 | 37 |
| Dielectric loss (25° C.) (%) | | |
| 100 Hz | 3.8 | 4.3 |
| 1 kHz | 2.9 | 2.0 |
| 10 kHz | 2.1 | 2.1 |
| Dielectric loss (100° C.) (%) | | |
| 100 Hz | 8.5 | 9.8 |
| 1 kHz | 5.5 | 8.3 |
| 10 kHz | 5.2 | 6.1 |
| Flexibility | ◯ | ◯ |

### Example 13

Aluminum was deposited on the dielectric film prepared in Example 1 with a vacuum evaporator by resistance heating to give a sheet resistance of 3 to 5Ω/□ to laminate and form an electrode layer, and thus a laminated film for a film capacitor was prepared.

### INDUSTRIAL APPLICABILITY

According to the present invention, by using compound oxide particles comprising a metallic element of the group II of from the second period to the fifth period in Periodic Table and a titanium element as a metallic element, there can be provided a highly dielectric film which has highly dielectric property, can be made thin, is excellent in winding property (flexibility) and assures a small dielectric loss.

1. A highly dielectric film comprising:
(A) a vinylidene fluoride type polymer, and
(B) compound oxide particles represented by the formula (B):
MₐTi_{b}O_{c}
wherein M is a metallic element of the group II of from the second period to the fifth period in Periodic Table; a is from 0.9 to 1.1; b is from 0.9 to 1.1; c is from 2.8 to 3.2, said compound oxide particles (B) are contained in an amount of 10 to 500 parts by mass based on 100 parts by mass of the vinylidene fluoride type polymer (A).

2. The highly dielectric film of claim 1, wherein a dielectric constant of the vinylidene fluoride type polymer (A) at 1 kHz at 25° C. is 5 to 15.

3. The highly dielectric film of claim 1, wherein the compound oxide particles (B) are particles of magnesium titanate, calcium titanate or strontium titanate.

4. The highly dielectric film of claim 1, wherein an average particle size of the compound oxide particles (B) is 0.01 to 2 μm.

5. The highly dielectric film of claim 1, having a dielectric constant at 1 kHz at 25° C. of 17 to 80, a dielectric loss of 0.2 to 7% and a thickness of 3 to 9 μm.

6. The highly dielectric film of claim 1, which is a film for a film capacitor.

7. A laminated film for a film capacitor prepared by laminating an electrode layer at least on one surface of the highly dielectric film of claim 1.

8. A film capacitor made by using the laminated film for a film capacitor of claim 7.

9. A coating composition for forming a highly dielectric film comprising:
(A) a vinylidene fluoride type polymer,
(B) compound oxide particles represented by the formula (B):
MₐTi_{b}O_{c}
wherein M is a metallic element of the group II of from the second period to the fifth period in Periodic Table; a is from 0.9 to 1.1; b is from 0.9 to 1.1; c is from 2.8 to 3.2,
(C) at least one affinity improving agent selected from the group consisting of a coupling agent, a surfactant and an epoxy group-containing compound, and
(D) a solvent,
said compound oxide particles (B) are contained in an amount of 10 to 500 parts by mass based on 100 parts by mass of the vinylidene fluoride type polymer (A) and said affinity improving agent (C) is contained in an amount of 0.01 to 30 parts by mass based on 100 parts by mass of the compound oxide particles (B).

10. The coating composition of claim 9, wherein a dielectric constant of the vinylidene fluoride type polymer (A) at 1 kHz at 25° C. is 5 to 15.

11. The coating composition of claim 9, wherein the compound oxide particles (B) are particles of magnesium titanate, calcium titanate or strontium titanate.

12. The coating composition of claim 9, wherein an average particle size of the compound oxide particles (B) is 0.01 to 2 μm.

13. The coating composition of claim 9, which is used for forming a highly dielectric film for a film capacitor.

14. A method of preparing a highly dielectric film, characterized by comprising a step for coating the coating composition of claim 9 on a substrate and a step for drying.
